(19) United States
(12) Patent Application Publication
(10) Pub. No.: US 2025/0328908 A1
(43) Pub. Date: Oct. 23, 2025

(54) PROTECTING DATA PRIVACY USING DATA-MASKING LABELS IN SYSTEMS PROVIDING REQUEST FULFILLMENT BY CONSORTIUM

(71) Applicant: Bank of America Corporation, Charlotte, NC (US)

(72) Inventors: George Albero, Charlotte, NC (US); Yuvraj Singh, Delhi (IN); Naga Vamsi Krishna Akkapeddi, Charlotte, NC (US); Durga Prasad Kutthumolu, Hyderabad (IN); Nagasubramanya Lakshminarayana, Concord, NC (US)

(21) Appl. No.: 18/640,816

(22) Filed: Apr. 19, 2024

(51) Int. Cl. G06Q 20/40

(52) U.S. Cl. CPC G06Q 20/4016; G06Q 20/405

(57) ABSTRACT

Aspects related to protecting data privacy using data-masking labels in systems providing request fulfillment by consortium are provided. A request fulfillment platform may train an analysis model to output smart contracts. The platform may receive an event processing request. The platform may identify a label corresponding to the event processing request. The platform may authenticate the event processing request based on the label. The platform may identify parameters of the event processing request based on information of a market corresponding to the event processing request. The platform may generate a complexity score for the event processing request based on inputting the label into the analysis model. The platform may generate an indication of whether fulfillment of the event processing request requires a consortium based on the complexity score. The platform may generate smart contracts based on the indication. The platform may send the smart contracts to a device.

### BACKGROUND

Aspects described herein are related to protecting data privacy using data-masking labels in systems providing request fulfillment by consortium. In some instances, entities such as an enterprise organization (e.g., a financial institution, and/or other institutions) may receive requests (e.g., event processing requests) from devices (e.g., user devices, such as laptops, cell phones, and the like, corresponding to employees and/or customers of the enterprise organization). In some instances, the requests may be requests to authorize, fund, and/or otherwise assist in establishing an economic venture. However, in some examples, the requests may include complexities (e.g., an amount of funding required, a number and/or type of relationships with other entities required, a history of interactions with the user submitting the request, a category of the request, and/or other complexities) that make it difficult or, in some examples, impossible for a single entity (e.g., a financial institution, and/or other institutions) to satisfy the request. Accordingly, it may be important to establish a system capable of identifying parameters and/or other requirements of a request to determine whether a consortium of entities is needed to satisfy the request. The system might need to be capable of causing fulfillment of the request by the consortium (e.g., by generating smart contracts between the origin of the request and the entities of the consortium, and/or by other means).

### SUMMARY

Aspects of the disclosure provide effective, efficient, scalable, and convenient technical solutions that address and overcome the technical problems associated with current methods of protecting data privacy using data-masking labels in systems providing request fulfillment. In accordance with one or more arrangements of the disclosure, a computing platform with at least one processor, a communication interface, and memory storing computer-readable instructions may train, based on historical event processing information, an analysis model. Training the analysis model may configure the analysis model to output smart contracts based on input of labels corresponding to event processing requests. The computing platform may receive, from a user device, an event processing request. The computing platform may identify, based on the event processing request, a label corresponding to the event processing request. The computing platform may authenticate, based on the label, the event processing request. The computing platform may identify, based on information of a market corresponding to the event processing request, one or more parameters of the event processing request. The computing platform may generate, based on inputting the label into the analysis model and based on the one or more parameters, a complexity score for the event processing request. The computing platform may generate, based on the complexity score, an indication of whether fulfillment of the event processing request requires a consortium. The computing platform may, based on an indication that fulfillment of the event processing request requires a consortium, generate a plurality of smart contracts corresponding to the event processing request. The computing platform may send, to the user device, the plurality of smart contracts.

In one or more examples, training the analysis model may comprise training, based on one or more historical optical tones corresponding to historical event processing requests, the analysis model to identify, based on optical tones, parameters of event processing requests. In one or more arrangements, the computing platform may generate, for a user, a user profile comprising authentication information of the user. Authenticating the event processing request may be further based on the user profile. In one or more examples, the computing platform may identify the one or more parameters of the event processing request by receiving, from a third party computing device, the information of the market corresponding to the event processing request. The computing platform may process, using an optical tone controller program and based on the label, the event processing request. Processing the event processing request may comprise identifying one or more portions of the event processing request for filtering. The computing platform may identify, based on processing the event processing request and based on the information of the market, the one or more parameters.

In one or more arrangements, the label corresponding to the event processing request may comprise an optical tone representing speech from a user. In one or more examples, the computing platform may identify the label corresponding to the event processing request by decoding, using an optical tone controller, the optical tone and comparing the optical tone to a user profile. In one or more arrangements, the computing platform may generate the indication of whether fulfillment of the event processing request requires a consortium by comparing the complexity score to a threshold score. The computing platform may identify, based on the comparison, whether the complexity score satisfies the threshold score. The computing platform may, based on identifying that the complexity score satisfies the threshold score, generate an indication that fulfillment of the event processing request requires a consortium or, based on identifying that the complexity score fails to satisfy the threshold score, generate an indication that fulfillment of the event processing request requires a consortium.

In one or more examples, the computing platform may generate the complexity score by generating, based on inputting the label and the one or more parameters into the analysis model, a record of the event processing request. The record of the event processing request may comprise one or more of: diligence information of the event processing request, a transaction type of the event processing request, user information associated with the event processing request, and/or security information associated with the event processing request. The computing platform may generate, based on applying weighted values to a plurality of portions of the event processing request, the complexity score. In one or more arrangements, the computing platform may, prior to generating the complexity score, identify, based on inputting the label into the analysis model and based on the one or more parameters, that the event processing request requires output of a notification. The computing platform may cause, based on identifying that the event processing request requires output of a notification, output of the notification.

In one or more examples, the computing platform may identify that the event processing request requires output of a notification by generating, based on inputting the label into the analysis model and based on the one or more parameters, a threat score for the event processing request. The computing platform may compare the threat score to a threshold score. The computing platform may identify, based on the comparison, whether the threat score satisfies the threshold score. The computing platform may, based on identifying that the threat score satisfies the threshold score, generate an indication that the event processing request requires output of a notification, or based on identifying that the threat score fails to satisfy the threshold score, generate an indication that the event processing request does not require output of a notification. In one or more arrangements, each smart contract of the plurality of smart contracts may correspond to a respective enterprise for fulfilling event processing requests. In one or more examples, the one or more parameters may comprise one or more of: a type of enterprise associated with the event processing request, a product associated with the event processing request, a funding amount associated with the event processing request, and/or an identification of a user associated with the event processing request. In one or more examples, the computing platform may update, based on the indication of whether fulfillment of the event processing request requires a consortium, the analysis model.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for protecting data privacy using data-masking labels in systems providing request fulfillment by consortium in accordance with one or more example arrangements;

FIGS. 2A-2E depict an illustrative event sequence for protecting data privacy using data-masking labels in systems providing request fulfillment by consortium in accordance with one or more example arrangements;

FIGS. 3A-3B depict illustrative graphical user interfaces generated as part of protecting data privacy using data-masking labels in systems providing request fulfillment by consortium in accordance with one or more example arrangements; and

FIG. 4 depicts an illustrative method for protecting data privacy using data-masking labels in systems providing request fulfillment by consortium in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to protecting data privacy using data-masking labels in systems providing request fulfillment by consortium. In some instances, entities such as an enterprise organization (e.g., a financial institution, and/or other institutions) may receive requests (e.g., event processing requests) from devices (e.g., user devices, such as laptops, cell phones, and the like, corresponding to employees and/or customers of the enterprise organization). In some instances, the requests may be requests to authorize, fund, and/or otherwise assist in establishing an economic venture (e.g., establishing a virtual storefront in a metaverse environment, funding a product line, investing in a start-up corporation, and/or other ventures). However, in some examples, the requests may include complexities (e.g., an amount of funding required, a number and/or type of relationships with other entities required, a history of interactions with the user submitting the request, a category of the request, and/or other complexities) that prevent a single entity from satisfying the request. Conventional methods of protecting data privacy using data-masking labels in systems providing request fulfillment may deny the request or require additional user action to satisfy the request. Currently, there is no mechanism for a system to efficiently and securely identify requests that require a consortium of entities to fulfill the request sent to a single entity.

Accordingly, in some instances, entities such as an enterprise organization (e.g., a financial institution, and/or other organizations/institutions) may deploy, maintain, and/or otherwise utilize a request fulfillment platform as described herein. A request fulfillment platform may identify parameters of event processing requests received from users (e.g., customers of the enterprise organization, and/or other users). The request fulfillment platform may, for example, identify parameters such as the type of request (e.g., funding request, loan request, permissions requests, requests for access to a metaverse environment, or the like), an amount of funding associated with a request, a source of the request, a timeline of the request, and/or any other parameters of the request. The request fulfillment platform may, based on identifying the parameters of the request, identify whether the request requires fulfillment by a consortium of entities (e.g., other enterprise organizations, such as financial institutions, investment institutions, or the like). The request fulfillment platform may, for example, generate a complexity score for the request based on the parameters of the request and/or other information related to the request. In some instances, the request fulfillment platform may gather information from a plurality of third party sources (e.g., other financial institutions, entities engaged in the same economic venture as the request, administrative/regulatory entities, and/or other sources). The request fulfillment platform may use some or all of the additional information gathered from third party sources to generate the complexity score for the request. The request fulfillment platform may, based on the complexity score, generate an indication of whether completion of the event processing request requires a consortium.

In some examples, a request fulfillment platform as described herein may further facilitate fulfillment of the request by generating smart contracts between a user initiating the request and the plurality of entities included in the consortium. The request fulfillment platform may, for example, identify a group of entities capable of fulfilling the request when acting as a consortium and generate smart contracts detailing the terms and conditions of fulfillment of the request for each party (e.g., each member of the consortium and the user initiating the request). The request fulfillment platform may provide the smart contracts to the user and/or to entities in the consortium.

In some instances, it may be important to ensure the aspects of protecting data privacy using data-masking labels in systems providing request fulfillment by consortium described herein are secure. Malicious actors, for example, may attempt to intercept and/or otherwise access information of the request and/or information gathered from third party sources. Accordingly, a request fulfillment platform as described herein may utilize authentication methods to authenticate requests from a device associated with a user. The user may, for example, use a device to record elements of a request. In some examples, the request may be associated with a metaverse environment (e.g., the request may be a request to establish a virtual storefront in a metaverse environment, and/or other requests associated with a metaverse environment). In these examples, the user may, for example, use a device to record speech, gestures, avatar information, and/or any other information related to making a request. The device may use one or more programs to capture the information from the user and generate a label (e.g., a bar code, a quick-response (QR) code, or the like) comprising the information of the request. Also or alternatively, in some examples, the request fulfillment platform may generate the label based on information received from the device. The label may mask the information of the request from potentially malicious sources. In some examples, the label may be, or be converted into, an optical tone. The request fulfillment platform may be configured to decode optical tones (e.g., using an optical tone controller, and/or other programs, devices, or the like) to identify the parameters of the request while maintaining the security of the request during transmission and decoding of the request. Additionally or alternatively, in some examples, request fulfillment platform may utilize quantum encryption/decryption techniques to identify the parameters of the request (e.g., based on the request being quantum-encrypted).

In some examples, in performing the methods of deploying and/or utilizing the request fulfillment platform as described herein, the request fulfillment platform may train one or more machine learning models. For example, the request fulfillment platform may train an analysis model based on historical event processing information from historical event processing requests. Training the analysis model may configure the analysis model to generate the complexity scores and/or output smart contracts based on input of labels (e.g., optical tones, bar codes, QR codes, or the like) corresponding to event processing requests.

These and various other aspects will be discussed more fully herein.

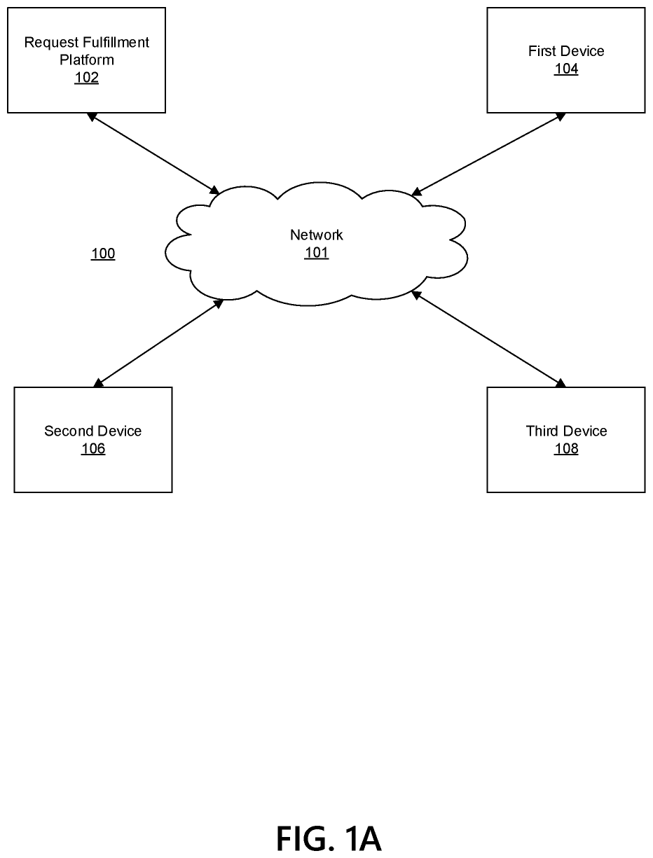

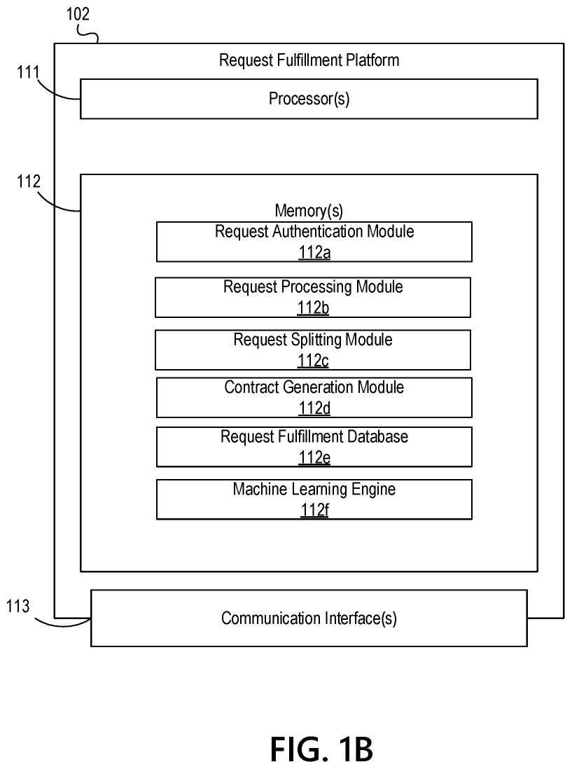

FIGS. 1A-1B depict an illustrative computing environment for protecting data privacy using data-masking labels in systems providing request fulfillment by consortium in accordance with one or more example arrangements. Referring to FIG. 1A, computing environment 100 may include one or more computer systems. For example, computing environment 100 may include a request fulfillment platform 102, a first device 104, a second device 106, a third device 108, and/or other computer systems.

As described further below, request fulfillment platform 102 may be a computer system that includes one or more computing devices (e.g., servers, laptop computer, desktop computer, mobile device, tablet, smartphone, and/or other devices) and/or other computer components (e.g., processors, memories, communication interfaces) that may be used to configure, train, and/or execute one or more machine learning models (e.g., an analysis model, and/or other models). For example, the request fulfillment platform 102 may train an analysis model to generate complexity scores and/or smart contracts for event processing requests. The complexity scores may be used to determine whether the request requires fulfillment by consortium. The request fulfillment platform 102 may be managed by and/or otherwise associated with an enterprise organization (e.g., a financial institution, and/or other institutions) that may, e.g., be associated with one or more additional systems (e.g., first device 104, second device 106, third device 108, and/or other systems). In one or more instances, the request fulfillment platform 102 may be configured to communicate with one or more systems (e.g., first device 104, second device 106, third device 108, and/or other systems) to perform an information transfer, decode an optical tone, identify parameters of an event processing request, generate complexity scores, generate indications of whether completion of event processing requests requires a consortium, generate smart contracts, display a user interface, and/or perform other functions.

The first device 104 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., generate labels (e.g., optical tones, or the like), generate event processing requests, and/or other functions). The first device 104 may possess and/or be associated with one or more identifying characteristics (e.g., an IP address, a geographical location, a MAC address, and/or other identifying characteristics). In some examples, the first device 104 may be associated with a particular user (e.g., an employee and/or a customer of the enterprise organization). In some instances, the first device 104 may be configured to communicate with one or more systems (e.g., request fulfillment platform 102, and/or other systems) as part of transmitting a message, sending an event processing request, and/or to perform other functions.

The second device 106 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other functions (e.g., provide information of a market related to the event processing request, provide information and/or parameters for completion of an event processing request, and/or other functions). For example, the second device 106 may be a computing device similar to the first device 104. In some examples, the second device 106 may be associated with a particular entity and/or organization (e.g., financial institutions, entities engaged in the same economic venture as the request, administrative/regulatory entities, and/or other entities/organizations). In some instances, the second device 106 may be configured to communicate with one or more systems (e.g., request fulfillment platform 102, and/or other systems) as part of transmitting a message, providing information of a market corresponding to an event processing request, and/or to perform other functions.

The third device 108 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other functions (e.g., displaying an interface, and/or other functions). For example, the third device 108 may be a computing device similar to first device 104 and/or second device 106. In one or more instances, third device 108 may correspond to an entity (e.g., an enterprise organization, such as a financial institution and/or other institution). For example, the third device 108 may correspond to the same entity associated with the request fulfillment platform 102. In one or more examples, the third device 108 may be associated with an administrator account/profile of the enterprise organization and may, for example, be configured to display alerts, notifications, or the like based on records of event processing requests. In one or more instances, the third device 108 may be configured to communicate with one or more systems (e.g., request fulfillment platform 102, and/or other systems) to receive transmissions, provide user feedback, and/or to perform other functions. In some instances, the third device 108 may be configured to display one or more graphical user interfaces (e.g., request alert interfaces, summary notification interfaces, and/or other interfaces).

Although three devices are depicted herein, any number of such devices may be used to implement the methods and arrangements described herein without departing from the scope of the disclosure.

Computing environment 100 also may include one or more networks, which may interconnect request fulfillment platform 102, first device 104, second device 106, and third device 108. For example, computing environment 100 may include a network 101 (which may interconnect, e.g., request fulfillment platform 102, first device 104, second device 106, and third device 108).

In one or more arrangements, request fulfillment platform 102, first device 104, second device 106, and third device 108 may be any type of computing device capable of sending and/or receiving requests and processing the requests accordingly. For example, request fulfillment platform 102, first device 104, second device 106, and third device 108, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of request fulfillment platform 102, first device 104, second device 106, and third device 108, may, in some instances, be special-purpose computing devices configured to perform specific functions.

Referring to FIG. 1B, request fulfillment platform 102 may include one or more processors 111, memory 112, and communication interface 113. A data bus may interconnect processors 111, memory 112, and communication interface 113. Communication interface 113 may be a network interface configured to support communication between request fulfillment platform 102 and one or more networks (e.g., network 101, or the like). Communication interface 113 may be communicatively coupled to the processors 111. Memory 112 may include one or more program modules having instructions that, when executed by processors 111, cause request fulfillment platform 102 to perform one or more functions described herein, and/or one or more databases (e.g., a request fulfillment database 112e, or the like) that may store and/or otherwise maintain information which may be used by such program modules and/or processors 111. In some instances, the one or more program modules and/or databases may be stored by and/or maintained in different memory units of request fulfillment platform 102 and/or by different computing devices that may form and/or otherwise make up request fulfillment platform 102. For example, memory 112 may have, host, store, and/or include a request authentication module 112a, a request processing module 112b, a request splitting module 112c, a contract generation module 112d, a request fulfillment database 112e, a machine learning engine 112f, and/or other modules and/or databases.

Request authentication module 112a may have instructions that direct and/or cause request fulfillment platform 102 to receive event processing requests, identify labels corresponding to event processing requests, generate user profiles, authenticate event processing requests, and/or perform other functions. Request processing module 112b may have instructions that direct and/or cause request fulfillment platform 102 to receive information from entities associated with a market corresponding to an event processing request, identify parameters of an event processing request, generate records of event processing requests and/or perform other functions. Request splitting module 112c may have instructions that direct and/or cause request fulfillment platform 102 to generate complexity scores for event processing requests, generate threat scores for event processing requests, generate indications of whether fulfillment of an event processing request requires a consortium, identify consortiums, split portions of an event processing request between members of a consortium, and/or perform other functions. Contract generation module 112d may have instructions that direct and/or cause request fulfillment platform 102 to generate smart contracts and/or perform other functions. Request fulfillment database 112e may have instructions causing request fulfillment platform 102 to store user profiles, parameters for event processing requests, information of markets associated with event processing requests, and/or other information. Machine learning engine 112f may have instructions to train, implement, and/or update one or more machine learning models, such as an analysis model, and/or other machine learning models.

Although request authentication module 112a, request processing module 112b, request splitting module 112c, contract generation module 112d, request fulfillment database 112c, and machine learning engine 112f are depicted as separate modules herein, the instructions stored by these modules may be stored in any number of modules without departing from the scope of this disclosure.

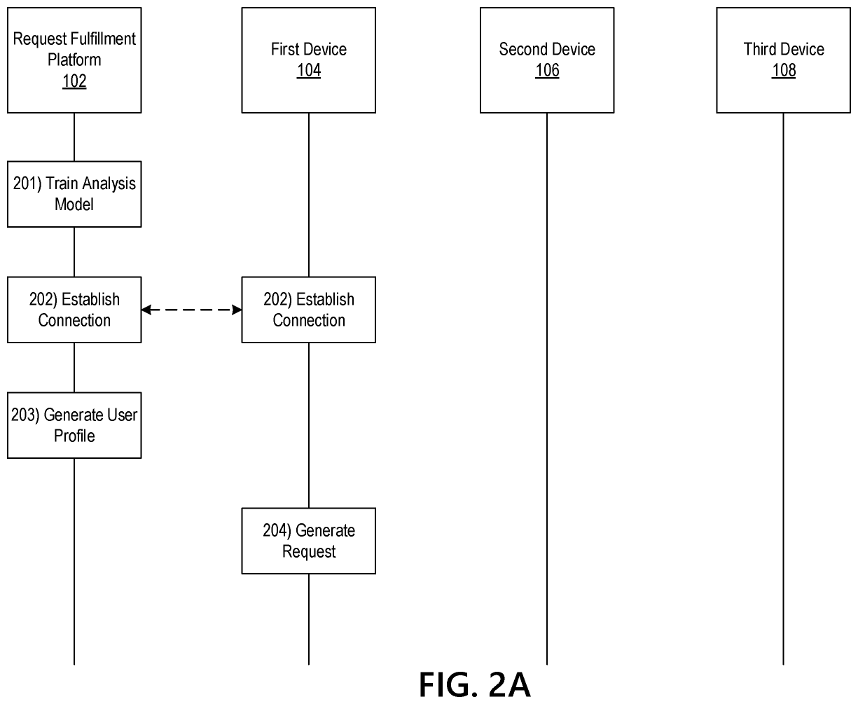

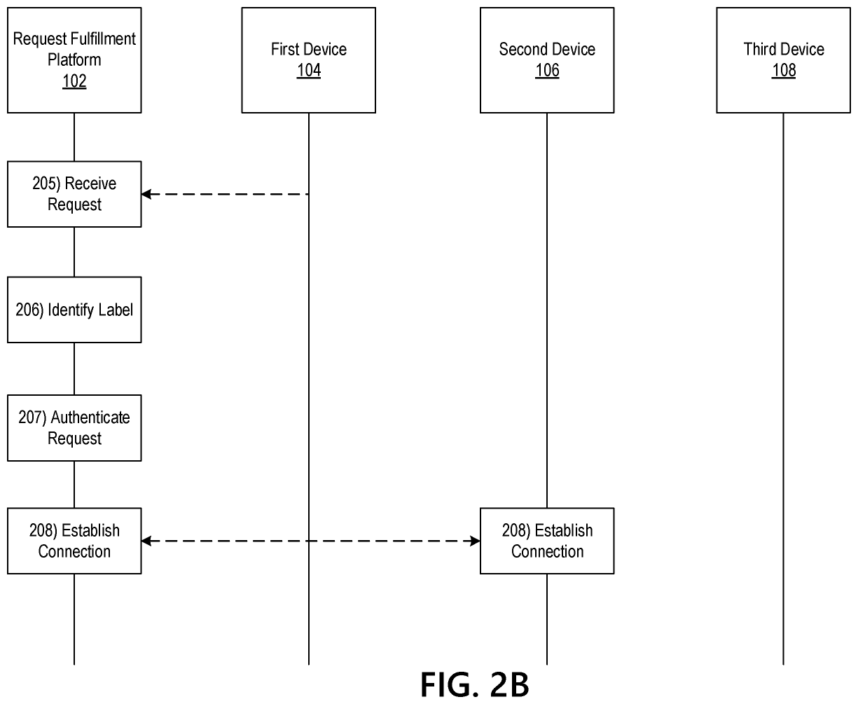

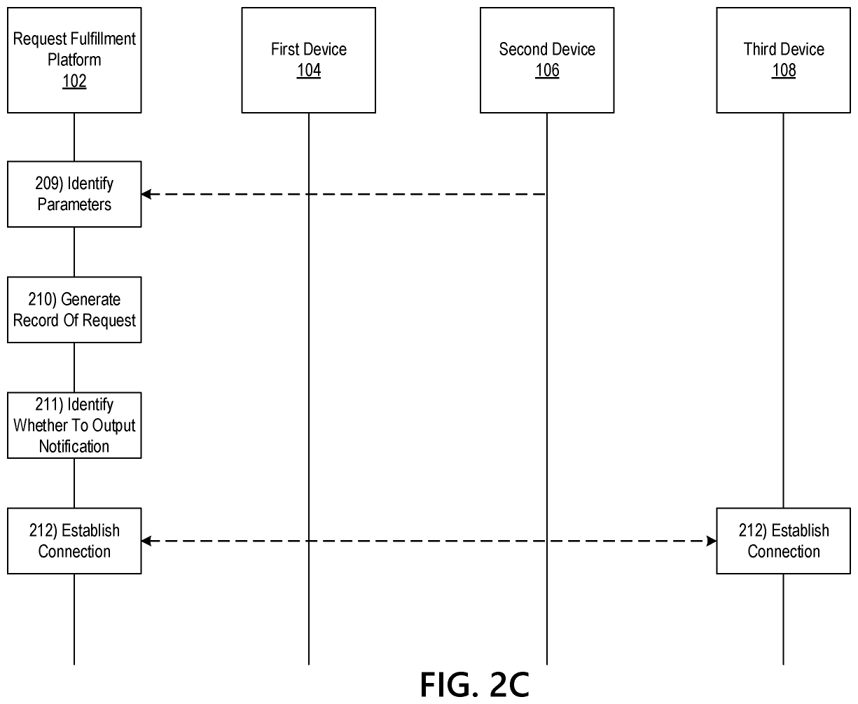

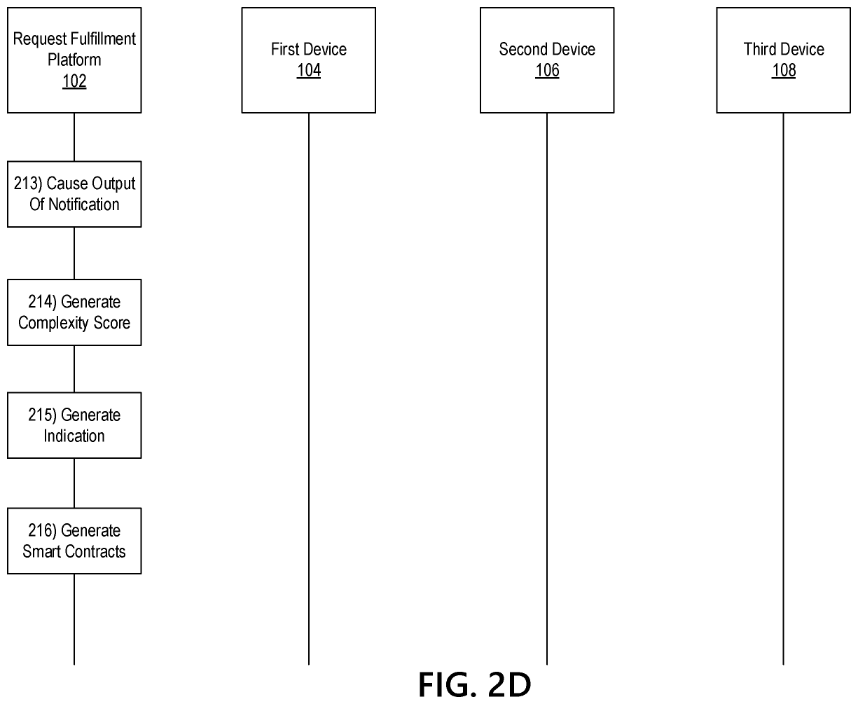

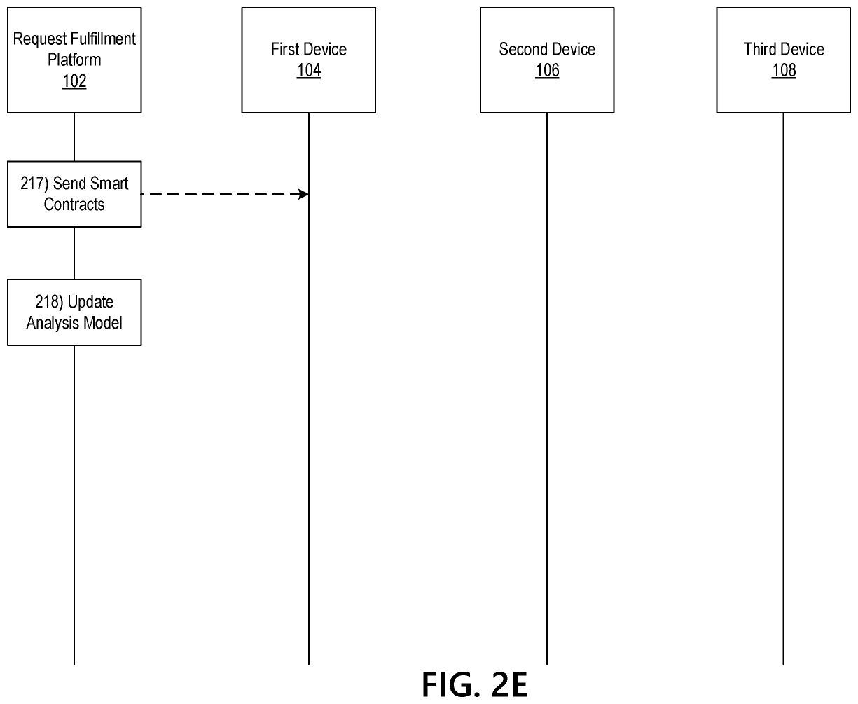

FIGS. 2A-2E depict an illustrative event sequence for protecting data privacy using data-masking labels in systems providing request fulfillment by consortium in accordance with one or more example arrangements. Referring to FIG. 2A, at step 201, the request fulfillment platform 102 may train a machine learning model. The request fulfillment platform 102 may, for example, train an analysis model configured to output smart contracts based on input of labels corresponding to event processing requests and/or based on input of event processing requests. In some instances, the request fulfillment platform 102 may configure and/or otherwise train the analysis model based on historical event processing requests. For example, the request fulfillment platform 102 may configure and/or otherwise train the analysis model based on historical event processing requests that were fulfilled by consortium, in order to train the model to identify event processing requests that require fulfillment by consortium. In some instances, to configure and/or otherwise train the analysis model, the request fulfillment platform 102 may process the historical event processing requests by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

In some examples, in configuring and/or otherwise training the analysis model, the request fulfillment platform 102 may cause the analysis model to store one or more correlations between information of historical event processing requests and determinations, indications, or the like identifying historical event processing requests as requests that required fulfillment by consortium. For example, based on an indication of a determination that a historical event processing request required fulfillment by consortium, the request fulfillment platform 102 may cause the analysis model to store one or more correlations between the indication of the determination and information of the historical event processing request that contributed and/or otherwise caused the determination that the historical event processing request required fulfillment by consortium. In some instances, for example, the request fulfillment platform 102 may cause the analysis model to store correlations between the indication of the determination that a historical event processing request required fulfillment by consortium and the parameters of the historical event processing request, such as the type of request (e.g., funding request, loan request, permissions requests, requests for access to a metaverse environment, or the like), an amount of funding associated with a request, a source of the request, a timeline of the request, and/or any other parameters of the historical event processing request. For example, the request fulfillment platform 102 may cause the analysis model to store one or more correlations between, for example, loan requests for an amount exceeding a threshold amount of capital and the indication of the determination.

Additionally or alternatively, in some examples, the request fulfillment platform 102 may train the analysis model based on one or more historical labels, such as optical tones, corresponding to the historical event processing requests. For example, the request fulfillment platform 102 may cause the analysis model to store one or more correlations between the labels of the event processing requests and the parameters of the historical event processing requests. In some examples, the request fulfillment platform 102 may cause the analysis model to store correlations based on decoding historical labels (e.g., optical tones, or the like) to identify keywords, gestures, and/or other information of the label and identifying corresponding parameters of the historical event processing request. For example, the request fulfillment platform 102 may cause the analysis model to store a correlation between a requirement that an event processing request be fulfilled by granting access to a metaverse environment and a portion of an optical tone indicating the event processing request is to establish, for example, a virtual storefront in a metaverse environment.

Additionally or alternatively, in some instances, the request fulfillment platform 102 may train the analysis model to output smart contracts based on input of labels corresponding to event processing requests by training the analysis model to generate complexity scores for event processing requests. For example, the request fulfillment platform 102 may train the analysis model to generate the complexity scores based on assigning scores, values, weights, or the like to particular parameters of an event processing request based on the one or more stored correlations described herein. In some examples, the request fulfillment platform 102 may train the analysis model to generate the complexity scores further based on additional context for an event processing request. For example, the request fulfillment platform 102 may train the analysis model to generate the complexity scores based on information of a market corresponding to the event processing request. For example, the request fulfillment platform 102 may train the analysis model to increase or decrease an initial complexity score, generated based on the parameters of an event processing request, based on a product type associated with the event processing request, a geographic location associated with the event processing request, financial information of the market for a product associated with the event processing request, information of and/or from other entities operating in the market for a product associated with the event processing request, and/or any other information associated with and/or otherwise corresponding to the market corresponding to the event processing request.

At step 202, the request fulfillment platform 102 may establish a connection with the first device 104. For example, the request fulfillment platform 102 may establish a first wireless data connection with the first device 104 to link the first device 104 with the request fulfillment platform 102 (e.g., in preparation for generating user profiles, receiving event processing requests, and/or other functions). In some instances, the request fulfillment platform 102 may identify whether or not a connection is already established with the first device 104. If a connection is already established with the first device 104, the request fulfillment platform 102 might not re-establish the connection. If a connection is not yet established with the first device 104, the request fulfillment platform 102 may establish the first wireless data connection as described herein.

At step 203, the request fulfillment platform 102 may generate a user profile. For example, the request fulfillment platform 102 may, based on establishing the first wireless data connection, generate a user profile for the user (e.g., a customer of an enterprise organization, such as a financial institution and/or other institutions, an employee of the enterprise organization, and/or other user) associated with the first device 104. The user profile may be and/or comprise information associated with the user. For example, the user profile may be and/or comprise information such as demographic information (e.g., names, usernames, account numbers, customer numbers, employee numbers, a location of the user (e.g., a home or work address), a status of the user (e.g., customer, remote employee, in-office employee, and/or other demographic information), device information (e.g., device identifiers such as an IP address, a MAC address, a device serial number, and/or other identifiers, geographic location associated with a device linked to the user, a version number of a program associated with the first device 104, an operating system associated with a device, and/or other device information), security information (e.g., a password, a passcode, or the like), and/or other information. In some examples, some or all of the information associated with the user may be authentication information used to authenticate event processing requests received from the device (e.g., the first device 104) associated with the user.

At step 204, the first device 104 may generate an event processing request. For example, the first device 104 may generate the event processing request based on user input. The request may be and/or comprise a request to authorize, fund, and/or otherwise assist in establishing an economic venture (e.g., establishing a virtual storefront in a metaverse environment, funding a product line, investing in a start-up corporation, and/or other ventures). In some examples, in generating the event processing request, the first device 104 may generate the event processing request based on user input gathered by contextual analysis. For example, the first device 104 may use one or more applications and/or programs to gather voice pattern information, pitch information, gesture information, and/or other information from the user making the event processing request. The one or more applications and/or programs may gather the information from one or more devices (e.g., microphones, cameras, virtual reality headsets, and/or other devices) authorized by the user to gather such information and that may be, and/or be connected to, the first device 104. In some instances, the first device 104 may generate a label (e.g., a QR code, a bar code, an optical tone, or the like) that represents the event processing request and/or the information comprising the event processing request. For example, the first device 104 may generate an optical tone comprising pitch labels generated based on a user's speech and/or gestures that represent the event processing request.

Referring to FIG. 2B, at step 205, the request fulfillment platform 102 may receive the event processing request. For example, the request fulfillment platform 102 may receive the event processing request via the communication interface 113 and while the first wireless data connection is established.

At step 206, the request fulfillment platform 102 may identify a label corresponding to the event processing request. For example, based on receiving the event processing request, the request fulfillment platform 102 may identify the label corresponding to the event processing request. In identifying the label, the request fulfillment platform 102 may identify and/or otherwise determine the information represented by the label corresponding to the event processing request. The request fulfillment platform 102 may identify the label using one or more applications, techniques, or the like configured to decode and/or otherwise identify labels masking other information (e.g., event processing request). For example, the request fulfillment platform 102 may utilize applications and/or techniques such as quantum decryption, visible light communication, optical tone controllers, barcode readers, QR code scanners, or the like to decode and/or otherwise identify the label corresponding to the event processing request. For instance, based on receiving an optical tone comprising the event processing request at step 205, the request fulfillment platform 102 may use an optical tone controller to decode the optical tone into specific pitch label formatting. In these instances, the request fulfillment platform 102 may identify the label, and the information corresponding to and/or indicated by the label, based on the decoded optical tone. In some examples, the request fulfillment platform 102 may identify the label corresponding to the event processing request by comparing the label to a maintained/user profile corresponding to the first device 104 and/or the user of first device 104. For example, the request fulfillment platform 102 may compare an optical tone corresponding to the event processing request to a user profile generated at step 203 to identify that the optical tone represents speech and/or gestures corresponding to the user associated with the user profile.

Additionally or alternatively, in some examples, the request fulfillment platform 102 may identify the label based on information from an intermediary device and/or service. For example, an optical tone service may decode an optical tone corresponding to the event processing request and encode a pitch label into a transaction tone using visible light communications light pulses. The request fulfillment platform 102 may receive the light pulses identifying the label (i.e., the optical tone) from the optical tone service.

At step 207, the request fulfillment platform 102 may authenticate the event processing request. In authenticating the event processing request, the request fulfillment platform 102 may compare the label to a user profile associated with the first device 104. For example, the request fulfillment platform 102 may have previously identified the label as an optical tone that represents speech and/or gestures corresponding to the user associated with the user profile. In these examples, the request fulfillment platform 102 may authenticate the event processing request by confirming, based on the user profile, that the speech and/or gestures represented by the optical tone authorize the event processing request to be fulfilled (e.g., based on one or more permissions and/or parameters included in the user profile and dictating what types of event processing requests may be made by the user). Additionally or alternatively, in authenticating the event processing request, the request fulfillment platform 102 may compare information of the event processing request to information of the user profile. For example, the request fulfillment platform 102 may compare a password, username, and/or other information of the event processing request to a password, username, and/or other information of the user profile to identify a match between the information of the event processing request and the information of the user profile. The request fulfillment platform 102 may, based on identifying a match, confirm that the event processing request is authenticated.

At step 208, the request fulfillment platform 102 may establish a connection with the second device 106. In establishing the connection with the second device 106, the request fulfillment platform 102 may establish a second wireless data connection with the second device 106 to link the second device 106 with the request fulfillment platform 102 (e.g., in preparation for receiving information from a third-party source (such as financial institutions, entities engaged in the same economic venture as the request, administrative/regulatory entities, and/or other entities/organizations, and/or other functions), and/or performing other functions). In some instances, the request fulfillment platform 102 may identify whether or not a connection is already established with the second device 106. If a connection is already established with the second device 106, the request fulfillment platform 102 might not re-establish the connection. If a connection is not yet established with the second device 106, the request fulfillment platform 102 may establish the second wireless data connection as described above. While only a single connection to second device 106 is described herein, it should be understood that the request fulfillment platform 102 may establish one or more additional connections with one or more additional devices similar to second device 106 and associated with third-party sources.

Referring to FIG. 2C, at step 209, the request fulfillment platform 102 may identify parameters of the event processing request. For example, the request fulfillment platform 102 may identify one or more requirements for fulfilling the event processing request and/or other information associated with fulfilling the event processing request. The one or more parameters may comprise the type of request (e.g., funding request, loan request, permissions requests, requests for access to a metaverse environment, or the like), an amount of funding associated with a request, a source of the request, a timeline of the request, a type of enterprise associated with the event processing request (e.g., retail business, investment business, advertising business, and/or other types of enterprise), a product associated with the event processing request, an identification of the user associated with the event processing request, a number and/or type of relationships with other entities required to fulfill the event processing request, a history of interactions with the user submitting the event processing request, and/or other parameters.

In some examples, the request fulfillment platform 102 may identify the parameters of the event processing request by parsing, decoding, and/or otherwise processing the information included in the event processing request and/or the label corresponding to the event processing request. For example, the request fulfillment platform 102 may utilize applications and/or techniques such as quantum decryption, visible light communication, optical tone controllers, barcode readers, QR code scanners, or the like to decode and/or otherwise process the event processing request and/or the label. The request fulfillment platform 102 may, for example, process the event processing request based on utilizing an optical tone controller program to decode the label (e.g., an optical tone, or the like) to identify one or more portions of the event process request for filtering. For example, based on processing the event processing request, the request fulfillment platform 102 may identify keywords of the event processing request defining the parameters of the event processing request, and may, in response, filter out any other portions of the event processing request.

Additionally or alternatively, in some examples, the request fulfillment platform 102 may identify the parameters of the event processing request based on the user profile. For example, the request fulfillment platform 102 may identify the user associated with the user profile has a history of timely repaying funding for fulfillment of event processing requests and may, in response, identify that funding for event processing requests associated with the user are authorized up to a particular amount of funding. Additionally or alternatively, in some examples the request fulfillment platform 102 may identify the parameters of the event processing request based on inputting the label corresponding to the event processing request into the analysis model. For example, based on inputting an optical tone into the analysis model, the request fulfillment platform 102 may identify the parameters of the event processing request based on one or more stored correlations between historical optical tones and historical event processing requests used to train the analysis model. For example, based on an optical tone representing speech requesting, for example, a second round of funding, the analysis model may identify, based on a stored correlation, that such speech indicates the event processing request requires funding in an amount equal to a first round of funding associated with a historical event processing request used to train the analysis model.

Additionally or alternatively, in some examples, the request fulfillment platform 102 may identify the parameters of the event processing request based on information of a market corresponding to the event processing request. In identifying the parameters of the event processing request based on information of a market corresponding to the event processing request, the request fulfillment platform 102 may receive the information of the market from one or more third-party sources, such as an entity associated with the second device 106. For example, the request fulfillment platform 102 may receive the information of the market via the communication interface 113 and while the second wireless data connection is established with the second device 106. The information of the market may comprise a product type associated with the event processing request, a geographic location associated with the event processing request, financial information of the market for a product associated with the event processing request, information of and/or from other entities operating in the market for a product associated with the event processing request, and/or any other information associated with and/or otherwise corresponding to the market corresponding to the event processing request. The request fulfillment platform 102 may identify the parameters of the event processing request based on comparing portions of the event processing request (e.g., keywords of the event processing request identified by processing an optical tone using an optical tone controller, and/or other portions of the event processing request) to the information of the market. For example, based on comparing a keyword of the event processing request indicating the request is for a virtual storefront in the metaverse to information of the market indicating an average cost for creating such a storefront, the request fulfillment platform 102 may identify, as a parameter, an amount of funding required to establish the virtual storefront.

It should be understood that any and/or all of the techniques described herein for identifying the parameters of the event processing request may be used together or separately from one another without departing from the scope of this disclosure.

At step 210, the request fulfillment platform 102 may generate a record of the event processing request. For example, the request fulfillment platform 102 may generate the record of the event processing request based on inputting the label corresponding to the event processing request and the parameters of the event processing request into the analysis model. In some examples, based on input of the label corresponding to the event processing request and the parameters of the event processing request, the analysis model may compile, aggregate, and/or otherwise combine information relevant to the event processing request into a single record (e.g., an electronic file, or the like). For example, the analysis model may combine the information relevant to the event processing request based on stored correlations between information such as a transaction type (e.g., deposit, withdrawal, funding, and/or other transaction types) associated with historical event processing requests, security information (e.g., required passwords, required permissions, required certificates, encryption requirements, or the like) associated with historical event processing requests, and/or stored correlations. Accordingly, the request fulfillment platform 102 may cause the analysis model to generate, based on the stored correlations, a record of the event processing request comprising similar information (e.g., transaction types of the event processing request, security information of the event processing request, and/or other information) to the information represented by the stored correlations.

Additionally or alternatively, in some examples, the request fulfillment platform 102 may generate a record of the event processing request that comprises user information associated with the event processing request. For example, based on the label corresponding to the event processing request, the request fulfillment platform 102 may generate a record of the event processing request comprising user information from the user profile indicated by the label. Additionally or alternatively, in some examples, the request fulfillment platform 102 may generate a record of the event processing request comprising diligence information of the event processing request. For example, the request fulfillment platform 102 may generate a record of the event processing request received from one or more third party sources (e.g., second device 106, or the like) as described herein. The diligence information may comprise information indicating a transaction history associated with the source of the event processing request, authentication information associated with historical event processing requests from the first device 104 to the second device 106, and/or other diligence information.

At step 211, the request fulfillment platform 102 may identify whether or not to output a notification corresponding to the event processing request. For example, the request fulfillment platform 102 may, based on inputting the label corresponding to the event processing request and the one or more parameters into the analysis model and/or based on the record of the event processing request, identify whether the event processing request requires output of a notification indicating the event processing request is associated with and/or susceptible to a security risk (e.g., a cyberattack, a violation of an administrative regulation, and/or other security risks).

In some examples, in identifying whether or not to output a notification corresponding to the event processing request, the request fulfillment platform 102 may cause the analysis model to identify a trigger criterion (e.g., a limit on an amount of funding a user may be granted, a suspicious parameter of the event processing request, and/or other trigger criterion) based on the label and/or the one or more parameters. For example, the analysis model may, based on identifying that the event processing request is a request for funding that exceeds a funding limit associated with the first device 104 and/or the user profile associated with the first device 104, identify that the event processing request requires output of a notification.

Additionally or alternatively, in some examples, the request fulfillment platform 102 may identify whether or not to output a notification based on generating a threat score for the event processing request. In some examples, the request fulfillment platform 102 may cause the analysis model to generate a threat score, based on inputting the label and the one or more parameters into the analysis model, representing a likelihood that the event processing request is associated with and/or susceptible to a security risk (e.g., a cyberattack, a violation of an administrative regulation, and/or other security risks). For example, the analysis model may generate the threat score using an algorithm assigning weighted values to one or more trigger criterion (e.g., a limit on an amount of funding a user may be granted, a suspicious parameter of the event processing request, and/or other trigger criterion). The analysis model may, for example, generate a threat score of 60% based on an algorithm assigning a weight of 20% to a suspicious parameter indicating that the event processing request requires an international transfer, a weight of 20% to a suspicious parameter indicating that the event processing request originated from an IP address different from an expected IP address, a weight of 20% to a suspicious parameter indicating that the event processing request was sent without encryption, and summing the weights. It should be understood that the above examples are merely illustrative and that other algorithms, weights, and/or trigger criteria may be used without departing from the scope of this disclosure. The threat score may be a percentage value, an integer value, a decimal value, and/or any other value.

In some examples, based on generating a threat score for the event processing request, the request fulfillment platform 102 may compare the threat score to a threshold score. The request fulfillment platform 102 may, based on identifying that the threat score meets or exceeds the threshold score, identify that the event processing request requires output of a notification. The request fulfillment platform 102 may, based on identifying that the threat score does not meet or exceed the threshold score, identify that the event processing request does not require output of a notification.

In some examples, based on identifying that the event processing request requires output of a notification, the request fulfillment platform 102 may proceed to step 212 to cause output of the notification. In some examples, based on identifying that the event processing request does not require output of a notification, the request fulfillment platform 102 may proceed to step 214 without performing the functions recited at step 212-213.

At step 212, based on identifying that the event processing request requires output of a notification, the request fulfillment platform 102 may establish a connection with the third device 108. For example, the request fulfillment platform 102 may establish the connection with the third device 108 to cause display of a notification, such as a request alert interface and/or other interface. In establishing the connection with the third device 108, the request fulfillment platform 102 may establish a third wireless data connection with the third device 108 to link the third device 108 with the request fulfillment platform 102 (e.g., in preparation for causing display of a user interface, and/or other functions). In some instances, the request fulfillment platform 102 may identify whether or not a connection is already established with the third device 108. If a connection is already established with the third device 108, the request fulfillment platform 102 might not re-establish the connection. If a connection is not yet established with the third device 108, the request fulfillment platform 102 may establish the third wireless data connection as described above.

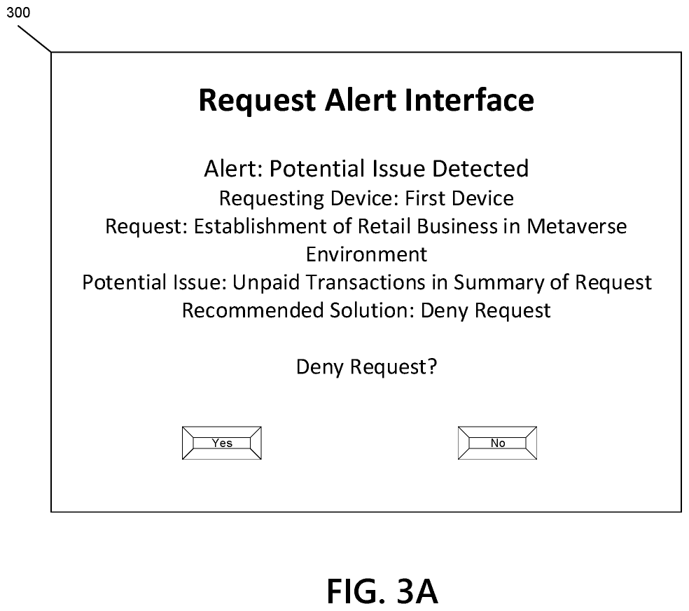

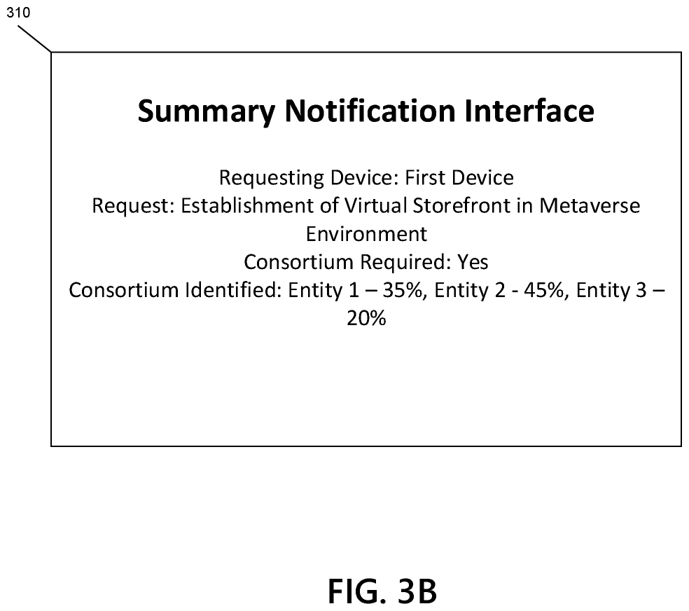

Referring to FIG. 2D, at step 213, the request fulfillment platform 102 may cause output of a notification. In some examples, in causing output of the notification, the request fulfillment platform 102 may cause display of a user interface. For example, the request fulfillment platform 102 may transmit and cause display of a request alert interface for notifying a user (e.g., an administrator of the enterprise organization associated with the request fulfillment platform 102, and/or other users) of a potential risk associated with the event processing request, and/or for receiving manual confirmation of whether to deny the event processing request or continue performing request fulfillment by consortium techniques described herein. In displaying the request alert interface, the request fulfillment platform 102 may cause display of a graphical user interface similar to request alert interface 300, which is illustrated in FIG. 3A. For example, the request fulfillment platform 102 may output one or more instructions (via the communication interface 113 and while the third wireless data connection is established) to the third device 108, causing the third device 108 to display the request alert interface 300.

Referring to FIG. 3A, in some instances, the request alert interface 300 may include information corresponding to the event processing request. For example, the request alert interface 300 may include information such as an alert that a potential issue and/or risk was detected, an indication of the source of the event processing request, a description of the event processing request and/or the record of the event processing request, a summary of the potential issues and/or risks detected, and/or other information. The request alert interface 300 may also display interface elements or selectable options requesting user input. For example, the request alert interface 300 may display one or more of: an information entry field, a button or buttons, toggle or toggles, check box or boxes, and/or other interface elements. For example, as illustrated in FIG. 3A, the interface elements may be one or more buttons the user might toggle or select to manually deny the event processing request. In some instances, based on user input/feedback denying the event processing request, the request fulfillment platform 102 may receive the user input/feedback and proceed to step 218 without performing further techniques for request fulfillment by consortium described at steps 214-217 herein. In some examples, based on user input/feedback indicating that the event processing request should not be denied, the request fulfillment platform 102 may proceed to step 214.

Referring back to FIG. 2D, at step 214, the request fulfillment platform 102 may generate a complexity score for the event processing request. For example, the request fulfillment platform 102 may generate the complexity score for the event processing request based on inputting the label corresponding to the event processing request and the one or more parameters of the event processing request into the analysis model. The complexity score may be an integer, decimal, fraction, percentage, binary value, alphabetical grade, and/or any other type of value indicating a complexity of the event processing request. The complexity score may represent a likelihood that the event processing request requires fulfillment by consortium. In some examples, the request fulfillment platform 102 may generate the complexity score for the event processing request by causing the analysis model to apply weighted values to portions of the event processing request. For example, the request fulfillment platform 102 may, based on the label corresponding to the event processing request, identify stored correlations corresponding to historical event processing requests sharing characteristics with the label corresponding to the event processing request. The analysis model may, based on the stored correlations, apply weighted values to portions (e.g., parameters) of the event processing request. For example, based on stored correlations indicating that event processing requests involving and/or requiring access to a metaverse environment historically correspond to a weighted value of, for example, 10%, the analysis mode may increase the complexity score for the event processing request by 10%. In some examples, the weighted values may decrease the complexity score based on portions (e.g., parameters) of the event processing request that indicate the event processing request may be fulfilled without a consortium. For example, the analysis model may apply a weighted value of −5% to a complexity score for an event processing request corresponding to a parameter indicating the event processing request should be fulfilled using funds from a single account.

In some examples, the analysis model may use one or more machine learning algorithms in generating the complexity score. For example, the request fulfillment platform 102 may have previously trained the analysis model to employ a scoring algorithm to generate complexity scores based on portions of the event processing request. For instance, the analysis model may execute the scoring algorithm using the following constraints/parameters:
If requested funding amount≥funding limit for enterprise A, Parameter A=10%; else, Parameter A=0%.
If requested funding amount≤balance of Account B, Parameter B=−10%; else, Parameter B=10%.
If request requires international transfer, Parameter C=10%; else, Parameter C=0%.

$$Complexity Score = Parameter A + Parameter B + Parameter C$$

In this example, the analysis model may execute the scoring algorithm to identify, based on comparing particular parameters of the event processing request to criteria for weighted values, weighted values to apply to parameters of the event processing request. Based on identifying the weighted values, the analysis model may generate the complexity score as the sum of the weighted values for each parameter.

It should be understood that the above example is merely one algorithm the analysis model may be trained to employ in order to generate the complexity score and in one or more instances additional or alternative algorithms may be employed and/or may correspond to different parameters (e.g., a funding amount, a category of venture associated with the event processing request, information of the record of the event processing request, and/or any other parameters described herein) and/or weighted values.

At step 215, the request fulfillment platform 102 may generate an indication of whether fulfillment of the event processing request requires a consortium. For example, the request fulfillment platform 102 may generate an indication of whether one or more parameters of the event processing request require that at least two entities (e.g., financial institutions, investment firms, regulatory entities, and/or any other entities) are required to fulfill the event processing request. In generating the indication of whether the event processing request requires a consortium, the request fulfillment platform 102 may compare the complexity score to a threshold score to identify whether the complexity score satisfies the threshold score. For example, based on comparing a complexity score of 60% to a threshold score satisfied by complexity scores that meet or exceed 50%, the request fulfillment platform 102 may identify that the complexity score satisfies the threshold score and that fulfillment of the event processing request requires a consortium. The request fulfillment platform 102 may generate an indication that fulfilment of the event processing request requires a consortium based on complexity scores that satisfy the threshold score. In some examples, in generating the indication of whether fulfillment of the event processing request requires a consortium, the request fulfillment platform 102 may generate an indication comprising the consortium (e.g., a list of entities identified by the request fulfillment platform 102 that are capable of fulfilling the event processing request).

At step 216, based on the indication of whether fulfillment of the event processing request requires a consortium, the request fulfillment platform 102 may generate smart contracts for the event processing request. The smart contracts may be and/or comprise one or more digital agreements comprising terms and conditions for fulfilling parameters of the event processing request. The smart contracts may indicate the parties responsible for fulfilling the event processing request (e.g., the enterprise associated with the request fulfillment platform 102, the enterprise associated with the second device 106, and/or any other entities). The request fulfillment platform 102 may, based on an indication that fulfilment of the event processing request requires a consortium, generate a plurality of smart contracts. For example, the request fulfillment platform 102 may generate a smart contract for each respective entity and/or enterprise of the consortium. The request fulfillment platform 102 may, based on an indication that fulfillment of the event processing request does not require a consortium, generate a single smart contract for the single entity and/or enterprise responsible for fulfillment of the event processing request.

Referring to FIG. 2E, at step 217, based on generating the smart contract and/or contracts, the request fulfillment platform 102 may send the smart contract and/or contracts to the first device 104. For example, the request fulfillment platform 102 may send the smart contract and/or contracts via the communication interface 113 and while the first wireless data connection is established. In some examples, in sending the smart contracts to the first device 104, the request fulfillment platform 102 may additionally cause display of a user interface indicating the smart contracts have been sent to the first device 104. For example, the request fulfillment platform 102 may transmit and cause display of a summary notification interface summarizing the results of the techniques for protecting data privacy using data-masking labels in systems providing request fulfillment by consortium described herein. In displaying the summary notification interface, the request fulfillment platform 102 may cause display of a graphical user interface similar to summary notification interface 310, which is illustrated in FIG. 3B. For example, the request fulfillment platform 102 may output one or more instructions (via the communication interface 113 and while the first wireless data connection is established) to the first device 104, causing the first device 104 to display the summary notification interface 310.

Referring to FIG. 3B, in some instances, the summary notification interface 310 may include information corresponding to the event processing request and the smart contracts. For example, the summary notification interface 310 may include information such as an indication of the source of the event processing request, a summary of the event processing request (e.g., the record of the event processing request), an indication of whether a consortium is required, an indication of the splitting, of the event processing request, between the members of the consortium based on the smart contracts, and/or other information.

Referring to FIG. 2E, at step 218, the request fulfillment platform 102 may refine, validate, and/or otherwise update the analysis model. For example, the request fulfillment platform 102 may update the analysis model based on the indication of whether fulfillment of the event processing request requires a consortium and/or based on the parameters of the event processing request. By inputting the parameters of the event processing request and/or the indication of whether fulfillment of the event processing request requires a consortium into the analysis model, the request fulfillment platform 102 may create an iterative feedback loop that may continuously and dynamically refine the analysis model to improve its accuracy. In some instances, updating the analysis model may include causing the analysis model to update one or more stored correlations based on the parameters of the event processing request and based on the indication of whether fulfillment of the event processing request requires a consortium. For example, the request fulfillment platform 102 may cause the analysis model to store new correlations and/or update existing correlations such that the analysis model may generate complexity scores for future event processing requests, with the same or similar parameters, in future iterations of the feedback loop based on the weights applied to the parameters of the event processing request described herein.

In updating the analysis model, the request fulfillment platform 102 may improve the accuracy of the model for generating indications of whether event processing requests require a consortium and/or generating complexity scores, which may, e.g., result in more efficient training of machine learning models trained by the request fulfillment platform 102 (and may in some instances, conserve computing and/or processing power/resources in doing so). The request fulfillment platform 102 may further increase the likelihood of detecting event processing requests that require a consortium to allow for improved matching of event processing requests to consortiums and increase the amount of event processing requests fulfilled by consortium.

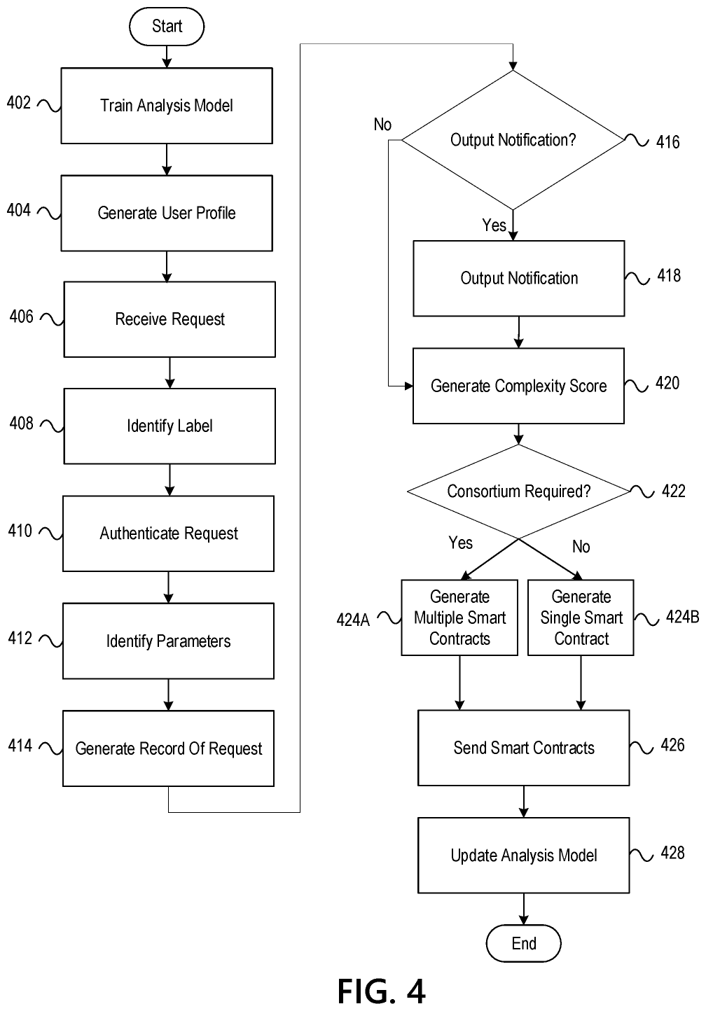

FIG. 4 depicts an illustrative method for protecting data privacy using data-masking labels in systems providing request fulfillment by consortium in accordance with one or more example arrangements. Referring to FIG. 4, at step 402, a computing platform having at least one processor, a communication interface, and memory may train a machine learning model. For example, the computing platform may train an analysis model to output smart contracts based on input of labels corresponding to event processing requests. At step 404, the computing platform may generate a user profile for a user corresponding to a device. At step 406, the computing platform may receive an event processing request. At step 408, the computing platform may identify a label corresponding to the event processing request. For example, the computing platform may identify an optical tone corresponding to the event processing request. At step 410, the computing platform may authenticate the event processing request. At step 412, the computing platform may identify the parameters of the event processing request. For example, the computing platform may identify the parameters of the event processing request based on the label of the event processing request and/or third party information. At step 414, the computing platform may generate a record of the event processing request. For example, the computing platform may generate the record of the event processing request using the analysis model.

At step 416, the computing platform may identify whether the event processing request requires output of a notification. For example, the computing platform may identify whether the event processing request requires output of a notification based on a threat score for the event processing request. Based on identifying that the event processing request does not require output of a notification, the computing platform may proceed to step 420. Based on identifying that the event processing request requires output of a notification, the computing platform may proceed to step 418. At step 418, based on identifying that the event processing request requires output of a notification, the computing platform may output the notification. At step 420, based on identifying that the event processing request does not require output of a notification or based on outputting the notification, the computing platform may generate a complexity score for the event processing request. For example, the computing platform may generate a complexity score for the event processing request using the analysis model. At step 422, the computing platform may identify whether a consortium is required. For example, the computing platform may generate an indication of whether fulfillment of the event processing request requires a consortium. Based on identifying that a consortium is required, the computing platform may proceed to step 424A. Based on identifying that a consortium is not required, the computing platform may proceed to step 424B.

At step 424A, based on identifying that a consortium is required, the computing platform may generate multiple smart contracts. For example, the computing platform may generate a smart contract for each member of a consortium. Based on generating multiple smart contracts, the computing platform may proceed to step 426. At step 424B, based on identifying that a consortium is not required, the computing platform may generate a single smart contract. Based on generating a single smart contract, the computing platform may proceed to step 426. At step 426, the computing platform may send the smart contract(s). For example, the computing platform may send the smart contract(s) to the device that sent the event processing request. At step 428, the computing platform may update the analysis model.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
train, based on historical event processing information, an analysis model, wherein training the analysis model configures the analysis model to output smart contracts based on input of labels corresponding to event processing requests;
receive, from a user device, an event processing request;
identify, based on the event processing request, a label corresponding to the event processing request;
authenticate, based on the label, the event processing request;
identify, based on information of a market corresponding to the event processing request, one or more parameters of the event processing request;
generate, based on inputting the label into the analysis model and based on the one or more parameters, a complexity score for the event processing request;
generate, based on the complexity score, an indication of whether fulfillment of the event processing request requires a consortium;
based on an indication that fulfillment of the event processing request requires a consortium, generate a plurality of smart contracts corresponding to the event processing request; and
send, to the user device, the plurality of smart contracts.

2. The computing platform of claim 1, wherein training the analysis model comprises:
training, based on one or more historical optical tones corresponding to historical event processing requests, the analysis model to identify, based on optical tones, parameters of event processing requests.

3. The computing platform of claim 1, wherein the memory stores additional computer-readable instructions that, when executed by the at least one processor, further configure the computing platform to:
generate, for a user, a user profile comprising authentication information of the user,
wherein the authenticating the event processing request is further based on the user profile.

4. The computing platform of claim 1, wherein the instructions, when executed, configure the computing platform to identify the one or more parameters of the event processing request by:
receiving, from a third party computing device, the information of the market corresponding to the event processing request;
processing, using an optical tone controller program and based on the label, the event processing request, wherein processing the event processing request comprises identifying one or more portions of the event processing request for filtering; and
identifying, based on processing the event processing request and based on the information of the market, the one or more parameters.

5. The computing platform of claim 1, wherein the label corresponding to the event processing request comprises an optical tone representing speech from a user.

6. The computing platform of claim 5, wherein the instructions, when executed, configure the computing platform to identify the label corresponding to the event processing request by:
decoding, using an optical tone controller, the optical tone; and
comparing the optical tone to a user profile.

7. The computing platform of claim 1, wherein the instructions, when executed, configure the computing platform to generate the indication of whether fulfillment of the event processing request requires a consortium by:
comparing the complexity score to a threshold score;
identifying, based on the comparison, whether the complexity score satisfies the threshold score; and
based on identifying that the complexity score satisfies the threshold score, generating an indication that fulfillment of the event processing request requires a consortium, or
based on identifying that the complexity score fails to satisfy the threshold score, generating an indication that fulfillment of the event processing request requires a consortium.

8. The computing platform of claim 1, wherein the instructions, when executed, configure the computing platform to generate the complexity score by:
generating, based on inputting the label and the one or more parameters into the analysis model, a record of the event processing request,
wherein the record of the event processing request comprises one or more of:
diligence information of the event processing request,
a transaction type of the event processing request,
user information associated with the event processing request, or
security information associated with the event processing request; and
generating, based on applying weighted values to a plurality of portions of the event processing request, the complexity score.

9. The computing platform of claim 1, wherein the memory stores additional computer-readable instructions that, when executed by the at least one processor, further configure the computing platform to:
prior to generating the complexity score, identify, based on inputting the label into the analysis model and based on the one or more parameters, that the event processing request requires output of a notification; and
cause, based on identifying that the event processing request requires output of a notification, output of the notification.

10. The computing platform of claim 9, wherein the instructions, when executed, configure the computing platform to identify that the event processing request requires output of a notification by:
generating, based on inputting the label into the analysis model and based on the one or more parameters, a threat score for the event processing request;
comparing the threat score to a threshold score;
identifying, based on the comparison, whether the threat score satisfies the threshold score; and
based on identifying that the threat score satisfies the threshold score, generating an indication that the event processing request requires output of a notification, or
based on identifying that the threat score fails to satisfy the threshold score, generating an indication that the event processing request does not require output of a notification.

11. The computing platform of claim 1, wherein each smart contract of the plurality of smart contracts corresponds to a respective enterprise for fulfilling event processing requests.

12. The computing platform of claim 1, wherein the one or more parameters comprise one or more of:
a type of enterprise associated with the event processing request,
a product associated with the event processing request,
a funding amount associated with the event processing request, or
an identification of a user associated with the event processing request.

13. The computing platform of claim 1, wherein the memory stores additional computer-readable instructions that, when executed by the at least one processor, further configure the computing platform to:
update, based on the indication of whether fulfillment of the event processing request requires a consortium, the analysis model.

14. A method comprising:
at a computing device comprising least one processor, a communication interface, and memory:
training, based on historical event processing information, an analysis model, wherein training the analysis model configures the analysis model to output smart contracts based on input of labels corresponding to event processing requests;
receiving, from a user device, an event processing request;
identifying, based on the event processing request, a label corresponding to the event processing request;
authenticating, based on the label, the event processing request;
identifying, based on information of a market corresponding to the event processing request, one or more parameters of the event processing request;
generating, based on inputting the label into the analysis model and based on the one or more parameters, a complexity score for the event processing request;
generating, based on the complexity score, an indication of whether fulfillment of the event processing request requires a consortium;
based on an indication that fulfillment of the event processing request requires a consortium, generating a plurality of smart contracts corresponding to the event processing request; and
sending, to the user device, the plurality of smart contracts.

15. The method of claim 14, further comprising:
generating, for a user, a user profile comprising authentication information of the user,
wherein the authenticating the event processing request is further based on the user profile.

16. The method of claim 14, wherein identifying the one or more parameters of the event processing request comprises:
receiving, from a third party computing device, the information of the market corresponding to the event processing request;
processing, using an optical tone controller program and based on the label, the event processing request, wherein processing the event processing request comprises identifying one or more portions of the event processing request for filtering; and
identifying, based on processing the event processing request and based on the information of the market, the one or more parameters.

17. The method of claim 14, wherein the label corresponding to the event processing request comprises an optical tone representing speech from a user.

18. The method of claim 14, wherein generating the indication of whether fulfillment of the event processing request requires a consortium comprises:
comparing the complexity score to a threshold score;
identifying, based on the comparison, whether the complexity score satisfies the threshold score; and
based on identifying that the complexity score satisfies the threshold score, generating an indication that fulfillment of the event processing request requires a consortium, or
based on identifying that the complexity score fails to satisfy the threshold score, generating an indication that fulfillment of the event processing request requires a consortium.

19. The method of claim 14, wherein generating the complexity score comprises:
generating, based on inputting the label and the one or more parameters into the analysis model, a record of the event processing request,
wherein the record of the event processing request comprises one or more of:
diligence information of the event processing request,
a transaction type of the event processing request,
user information associated with the event processing request, or
security information associated with the event processing request; and
generating, based on applying weighted values to a plurality of portions of the event processing request, the complexity score.

20. One or more non-transitory computer-readable media storing instructions that, when executed by a computing platform comprising at least one processor, a communication interface, and memory, cause the computing platform to:
train, based on historical event processing information, an analysis model, wherein training the analysis model configures the analysis model to output smart contracts based on input of labels corresponding to event processing requests;
receive, from a user device, an event processing request;
identify, based on the event processing request, a label corresponding to the event processing request;
authenticate, based on the label, the event processing request;
identify, based on information of a market corresponding to the event processing request, one or more parameters of the event processing request;
generate, based on inputting the label into the analysis model and based on the one or more parameters, a complexity score for the event processing request;
generate, based on the complexity score, an indication of whether fulfillment of the event processing request requires a consortium;
based on an indication that fulfillment of the event processing request requires a consortium, generate a plurality of smart contracts corresponding to the event processing request; and
send, to the user device, the plurality of smart contracts.
